(19) United States
(12) Patent Application Publication
(10) Pub. No.: US 2025/0384641 A1
(43) Pub. Date: Dec. 18, 2025

(54) CREATING PHYSICS-BASED CONTENT

(71) Applicant: Lemon Inc., Grand Cayman (KY)

(72) Inventors: Weston Bell-Geddes, Los Angeles, CA (US); Jie Li, Los Angeles, CA (US); Xinhao Song, Los Angeles, CA (US); Yili Zhao, Los Angeles, CA (US); Zhili Chen, Los Angeles, CA (US)

(21) Appl. No.: 18/743,880

(22) Filed: Jun. 14, 2024

(51) Int. Cl. G06T 19/20; G06T 19/00

(52) U.S. Cl. CPC G06T 19/20; G06T 19/006; G06T 2200/24; G06T 2210/21; G06T 2219/2016

(57) ABSTRACT

The present disclosure describes techniques for creating physics-based content. A set of physics tools can be established. The set of physics tools can enable implementation of physics simulations in a three-dimensional (3D) environment. Each of the set of physics tools can comprise customizable physical properties. User interfaces configured to facilitate application of the physics simulations in the 3D environment can be presented. Objects and interactions in the 3D environment can be configured by utilizing the set of physics tools based on user input received via the user interfaces. Interactive effects can be created based on the configured objects and interactions.

### BACKGROUND

Communication is increasingly being conducted using Internet-based tools. The Internet-based tools may be any software or platform. Users may create content and design features via such Internet-based tools. Improved techniques for content creation and feature design via such tools are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for creating physics-based content in accordance with the present disclosure.

FIG. 2 shows an example user interface for creating physics-based content in accordance with the present disclosure.

FIG. 3 shows an example user interface for creating physics-based content in accordance with the present disclosure.

FIG. 4 shows an example user interface for creating physics-based content in accordance with the present disclosure.

FIG. 5 shows an example user interface for creating physics-based content in accordance with the present disclosure.

FIG. 6 shows an example user interface for creating physics-based content in accordance with the present disclosure.

FIG. 7A shows an example user interface for creating physics-based content in accordance with the present disclosure.

FIG. 7B shows an example user interface for creating physics-based content in accordance with the present disclosure.

FIG. 8A shows an example user interface for creating physics-based content in accordance with the present disclosure.

FIG. 8B shows an example user interface for creating physics-based content in accordance with the present disclosure.

FIG. 9 shows an example user interface for creating physics-based content in accordance with the present disclosure.

FIG. 10 shows an example process for creating physics-based content in accordance with the present disclosure.

FIG. 11 shows an example process for creating physics-based content in accordance with the present disclosure.

FIG. 12 shows an example process for creating physics-based content in accordance with the present disclosure.

FIG. 13 shows an example process for creating physics-based content in accordance with the present disclosure.

FIG. 14 shows an example process for creating physics-based content in accordance with the present disclosure.

FIG. 15 shows an example process for creating physics-based content in accordance with the present disclosure.

FIG. 16 shows an example process for creating physics-based content in accordance with the present disclosure.

FIG. 17 shows an example computing device which may be used to perform any of the techniques disclosed herein.

### DETAILED DESCRIPTION OF ILLUSTRATIVE EMBODIMENTS

To create interactive games and effects, such as mini-game effects, creators can use content creation platforms. Such games and effects may require physics interactions between various components. However, existing content creation platforms are often unable to generate high-quality (e.g., realistic looking) physics interactions between various components. For example, existing content creation platforms have limited physics simulation capabilities. Many existing content creation platforms rely on manual processes for implementing basic physics interactions, such as object positioning and simple motion, but do not support advanced physics simulations, such as dynamic objects, detailed collision responses, or realistic material interactions. This may prevent the creation of games and effects that require nuanced physical behaviors and may reduce the overall quality and realism of the created games and effects. Further, many existing content creation platforms have inadequate customization options. The lack of customizable physics materials and settings (e.g., adjusting friction, bounciness, and gravity) constrains creators, preventing them from tailoring the physics to match the specific needs of the project. This one-size-fits-all approach can lead to a homogenization of game effects, diminishing the potential for innovation.

The content creation process enabled by many existing content creation platforms is complex and inefficient. Without a comprehensive and intuitive toolset, creators must resort to manual and time-consuming methods to approximate physics interactions. This process is not only inefficient but is also inaccessible to creators without extensive technical expertise, effectively raising the barrier to entry for physics-based game and effect creation. Further, existing content creation platforms are often unable to successfully integrate with augmented reality (AR) and interactive games. Existing technologies often overlook the unique requirements of AR and interactive games, such as the need for real-time physics simulations that respond to user inputs and camera movements. This oversight results in a disconnect between the physical simulation and the interactive elements of AR experiences, undermining user engagement and immersion.

These shortcomings of existing content creation platforms collectively contribute to an ecosystem where creators are limited in their ability to produce high-quality, physics-based interactive games and AR effects. The gap between the potential of physics in digital creation and the capabilities offered by existing technologies highlighted the need for a solution that can bridge this divide, empowering creators with the tools necessary to realize their visions without compromise.

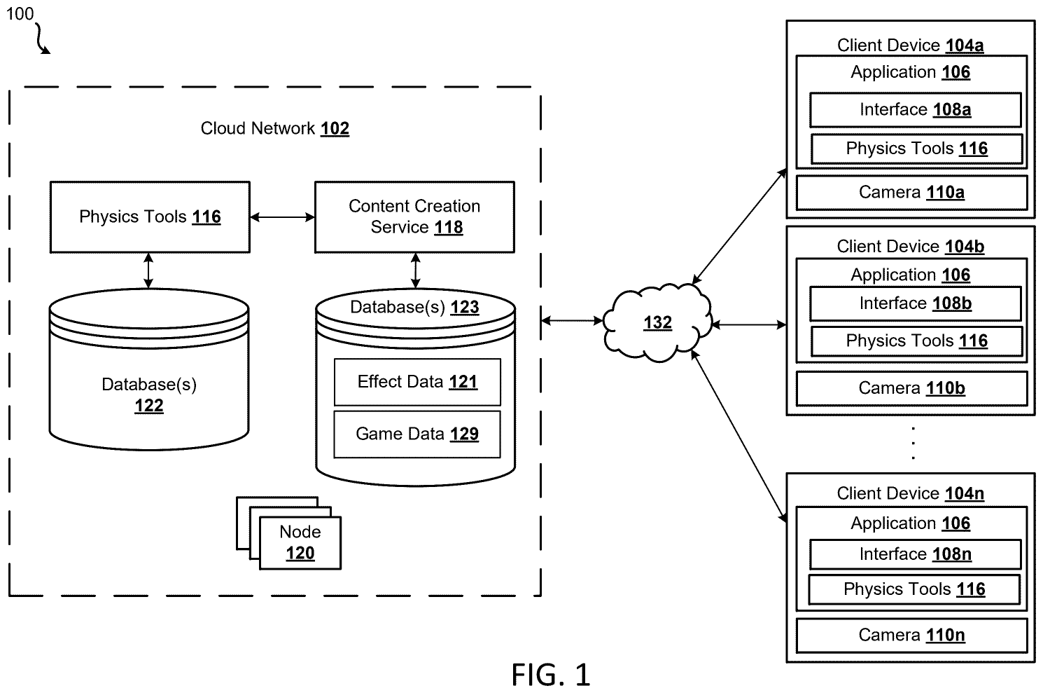

Described herein are improved techniques for creating physics-based content. FIG. 1 shows an example system 100 for creating physics-based content, such as interactive effects or games. The system 100 can include a cloud network 102 and a plurality of client devices 104a-n (collectively, 104). The cloud network 102 and the plurality of client devices 104a-n can communicate with each other via one or more networks 132.

The cloud network 102 may be located at a data center, such as a single premise, or be distributed throughout different geographic locations (e.g., at several premises). The cloud network 102 may provide services, such as a content creation service 118, via the one or more networks 132. The network 132 comprise a variety of network devices, such as routers, switches, multiplexers, hubs, modems, bridges, repeaters, firewalls, proxy devices, and/or the like. The network 132 may comprise physical links, such as coaxial cable links, twisted pair cable links, fiber optic links, a combination thereof, and/or the like. The network 132 may comprise wireless links, such as cellular links, satellite links, Wi-Fi links and/or the like.

The cloud network 102 may comprise a plurality of computing nodes 120 that host a variety of services. In an embodiment, the nodes 120 host the content creation service 118. The content creation service 118 may be configured to facilitate the creation/design of content, such as effects and/or games, by a creator or designer (e.g., user, developer) associated with a client device of the plurality of client devices 104a-n. For example, the plurality of client devices 104a-n may each be associated with content creator(s) or designers that want to create or design content. The plurality of client devices 104a-n may comprise an application 106. In some embodiments, the application 106 may establish a set of physics tools 116. In other embodiments, the set of physics tools 116 may be utilized by the content creation service 118. The set of physics tools will be described in detail below. The application 106 may be used by the creator(s)/designer(s) to create/design content. For example, the creator(s)/designer(s) can access interface(s) 108a-n (collectively, 108) of the application 106 to create/design content.

The plurality of client devices 104a-n may comprise any type of computing device, such as a mobile device, a tablet device, laptop, a desktop computer, a smart television or other smart device (e.g., smart watch, smart speaker, smart glasses, smart helmet), a gaming device, a set top box, digital streaming device, robot, and/or the like. A single user may use one or more of the client devices 104a-n to access the cloud network 102. The plurality of client devices 104a-n may travel to a variety of locations and use different networks to access the cloud network 102. The content creation service 118 can utilize the set of physics tools 116 to facilitate the creation of content, such as effects and/or games, by a creator (e.g., user, designer, developer) associated with one of the client devices 104a-n. The set of physics tools 116 enables the content creation service 118 and/or the application 106 to implement physics simulations in a three-dimensional (3D) environment. Each physics tool of the set of physics tools 116 can include customizable physical properties.

The set of physics tools 116 can include one or more rigid body components. The rigid body component(s) can each include customizable physical properties, such as properties of mass, damping (a decrease in the amplitude of an oscillation as a result of energy being drained from the system to overcome frictional or other resistive forces), angular damping (a decrease in the amplitude of an oscillation as a result of energy being drained from the system to overcome frictional or other resistive forces), external force (force resulting from the interaction between the component and its environment), external torque (the rotational force applied by an external force to an object, causing it to rotate around an axis), and/or a freeze option for motion along specified axes.

The set of physics tools 116 can further include one or more collider components. The collider component(s) can include a box collider configured to detect and simulate collisions involving box-shaped objects. The collider component(s) can include a sphere collider configured to detect and simulate collisions involving sphere-shaped objects. The collider component(s) can include a capsule collider configured to detect and simulate collisions involving capsule-shaped objects. The set of physics tools 116 can also include one or more joint components. The joint component(s) can include fixed joints, point joints, spring joints, and/or hinge joints. The joint components can simulate physical connections between objects.

The set of physics tools 116 can enable to implement physics simulations in a 3D environment. A user can input, via the interface 108 on the client device 104, data indicating a desired configuration of various objects and interactions between the objects in the 3D environment. In embodiments, a rigid body component comprised in the set of physics tools 116 can be assigned to one or more objects in the content. The interface 108 enables the user to specify the properties of each rigid body component, such as a mass, a damping, an angular damping, an external force, an external torque, and/or whether the user wants the motion of the rigid body to be frozen along one or more specified axes (e.g., x-axis, y-axis, z-axis). The set of physics tools 116 enable the user to assign a rigid body component to object(s) in the content. By assigning a rigid body component to object(s) in the content using the set of physics tools 116, the user can specify the properties of object(s) in the content, thereby enabling realistic physics simulations for the content.

In embodiments, a collider component comprised in the set of physics tools 116 can be assigned to one or more objects in the content. A box collider, a sphere collider, or a capsule collider can be assigned to the object, depending on a shape of the object. For example, if the object is spherical, a sphere collider can be assigned to the object. A collider component in the set of physics tools 116 can be assigned to an object if the user/creator wants the object to collide with at least one other object. Physical interaction properties associated with the collision of the objects can be defined by incorporating a physics matter to each of the collider components. The physical interaction properties can include different types of friction (e.g., dynamic friction, static friction), bounciness, and gravity. The user can select a desired value (e.g., level) of dynamic friction, static friction, bounciness, and/or gravity associated with each collider component, allowing for more nuanced and diverse content creation.

In embodiments, a joint component comprised in the set of physics tools 116 can be assigned to objects in the content. A fixed joint can be assigned to two or more objects in the content to connect the two or more objects to each other with no movement relative to each other. A hinge joint can be assigned to two or more objects in the content to connect the two or more objects to each other while permitting rotational movement around a single axis. A spring joint can be assigned to two or more objects in the content to connect the two or more objects to each other while allowing spring-like movement of the two or more objects.

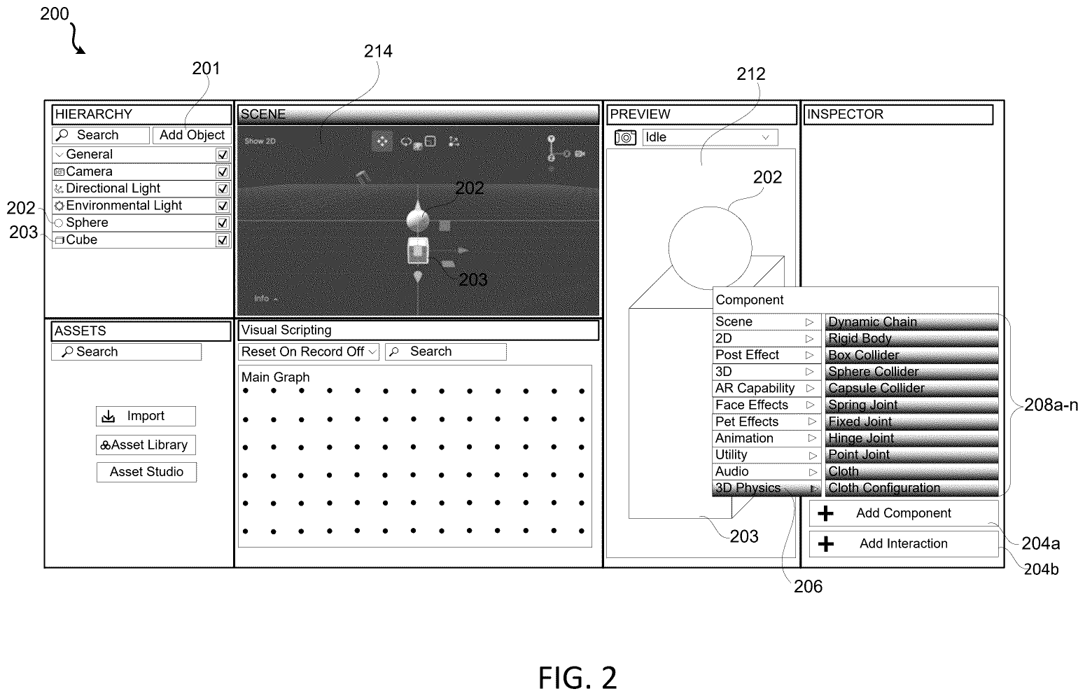

For example, with reference to FIG. 2, the content creation service 118 and/or the application 106 can cause to present the user interface (UI) 200. The user can view the UI 200. To begin creating content, a user can add one or more objects. To add the object(s), the user can select a user interface element (e.g., button) 201. The objects can include, for example, a sphere 202 and a cube 203.

The UI 200 can comprise a preview window 212 of displaying the objects/interactions in a 3D environment incorporated with real-time camera inputs. The preview window 212 can display in real time a current design/creation state of the content (e.g., how the content would look if no more changes or modifications are made to the content). The UI 200 can present a scene 214 representing the 3D environment. The scene area can display in real time any changes of objects/interactions in the 3D environment.

The user can assign/add components and/or interactions to the objects in the 3D environment (e.g., the sphere 202 and/or to the cube 203). To add components and/or interactions to the objects, the user can select a user interface element (e.g., button) 204a or 204b. By selecting the user interface element 204a and/or 204b, the user can add a component and/or interaction to the content. Components and/or connections from a set of physics tools (e.g., the set of physics tools 116) can be added/assigned to the objects in the 3D environment via a user interface element, e.g., the “3D Physics” element 206 as shown in FIG. 2.

In response to the user selecting the interface element 206, indicators 208a-n of the set of physics tools (e.g., physics tools 116) can be displayed on the screen. The set of physics tools can include a rigid body, collider components (e.g., a box collider, a sphere collider, a capsule collider), and joint components (e.g., a spring joint, a fixed joint, a hinge joint, a point joint). The user can select one or more desired indicators representing one or more physics tools from the indicators 208a-n. For example, the user can select the “rigid body” tool to assign a rigid body component to an object (e.g., the sphere 202 or the cube 203) in the 3D environment. Likewise, the user can select the “box collider” tool to assign a collider component to the cube 203 and can select the “sphere collider” tool to assign a collider component to the sphere 202.

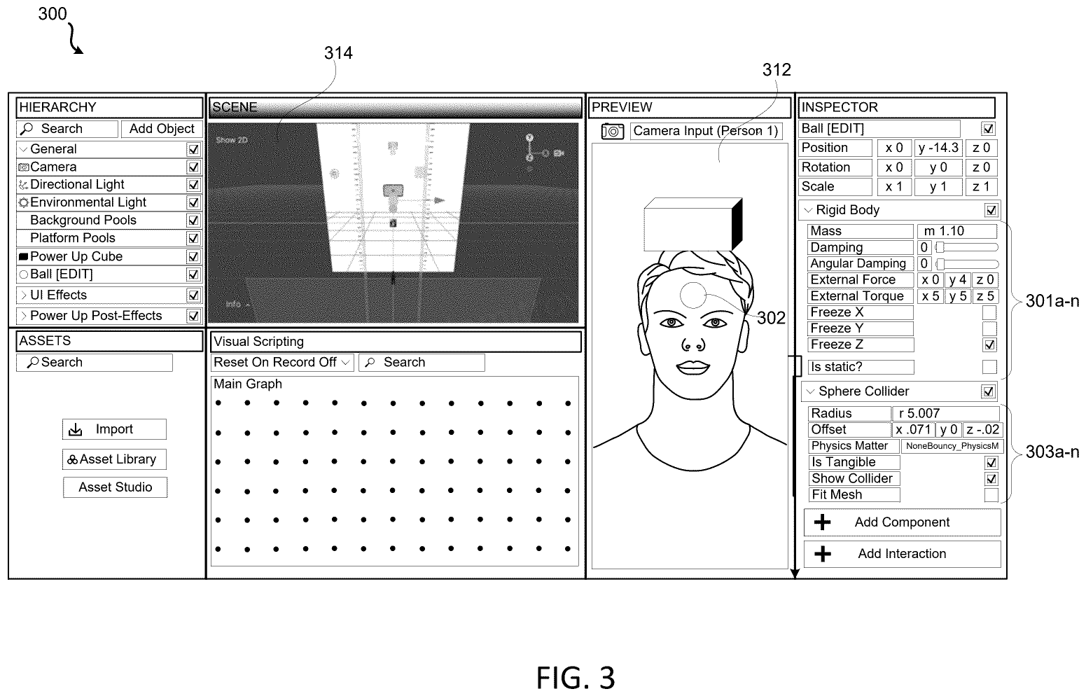

As shown in FIG. 3, the content creation service 118 and/or the application 106 can cause to present the user interface (UI) 300. The user can customize physical properties of components/interactions comprised in the set of physics tools. For example, the “rigid body” tool can be utilized to assign a rigid body component to a ball 302 in a 3D environment. The rigid body component can be customized using the user interface elements 301a-n, thereby enabling realistic physics simulations for objects within content. The user can customize the mass of the rigid body component. For example, the user can assign a value (e.g., numeral value) to the mass of the object. The mass of the object determines the inertia of the object in the 3D environment. The user can customize the damping and/or angular damping of the rigid body component. For example, the user can control the linear and rotational motion decay, respectively, with values ranging from 0 to 1. The user can customize the external force and/or the external torque of the object in the 3D environment. For example, the user can apply forces, such as rotational forces, to the object in three dimensions (X, Y, Z), facilitating dynamic interactions. The user can indicate whether the user wants the motion of the rigid body component to be frozen (e.g., restricted) along one or more specified axes (e.g., x-axis, y-axis, z-axis), such as to provide stability and control in simulations. The user can specify whether the rigid body component assigned to the ball 302 is static (e.g., immovable). The user may want the rigid body component to be static to make the object serve as a static obstacle or environmental element.

As shown in the example of FIG. 3, the user can assign a mass of 1.10 (e.g., 1.10 kg) to the rigid body component. The user can specify that the external force applied in the y-direction has a force of a particular value, e.g., 4. The user can specify that an external torque of 5 (e.g., 5 Newton meters) is applied in the x-direction, y-direction, and z-direction. The user can specify that motion of the rigid body component is to be frozen in the z-direction (e.g., the ball 302 cannot move in the z-direction). As the properties of the rigid body component are customized, the preview window 312 and the scene 314 can be updated in real time.

In embodiments, the user can select the “sphere collider” tool to assign a collider component to the ball 302 in the 3D environment. The user can edit the properties associated with the sphere collider component assigned to the ball 302 using the user interface elements 303a-n. The user can edit the radius, offset, the physics matter, whether the sphere collider component is tangible, whether the sphere collider component should be visible, and/or whether the user wants a mesh to be fit to the sphere collider component.

Fitting a mesh to the sphere collider component can include automatically adjusting the sphere collider component to match a mesh size of the object (e.g., the ball 302) to enhance efficiency of effect creation. When the “fit mesh” feature is enabled for a sphere collider, the content creation service 118 and/or the application 106 can calculate a bounding sphere of the attached mesh. The bounding sphere is the smallest possible sphere that completely surrounds the mesh. The radius of the bounding sphere can be used to set the radius of the sphere collider. The center of the bounding sphere can be used to set the center of the sphere collider. The sphere collider can update in real-time as changes are made to the mesh. If the mesh is modified, the sphere collider can automatically adjust its radius and center to fit the new shape of the mesh. The dimensions of the sphere collider can be adjusted to fit the mesh when the component is initially added. After that, the creator can manually adjust the dimensions of the collider as needed. If the “fit mesh” button is pressed, the dimensions of the collider can be reset to fit the mesh.

As shown in the example of FIG. 3, the user can assign a radius of a particular value (e.g., 5.0007) to the sphere collider component. The user can specify that the offset of the sphere collider component is 0.071 in the x-direction, 0 in the y-direction, and −0.2 in the z-direction. The user can specify that the sphere collider component is to be tangible and visible. As the user updates the properties of the sphere collider component, the preview window 312 and the scene 314 can be updated in real time.

The preview window 312 can show the user a current design state of the content, such as how the ball 302 looks after applying the rigid body component and the sphere collider component to the ball 302. The 3D environment can be integrating with real-time user and camera inputs. For example, a feed of a camera (e.g., camera 110a-n) can be combined with the 3D environment. In the example of FIG. 3, the preview window 312 displays the real time feed of the camera (e.g., images or a video of a person) integrated with the 3D environment comprising the ball 302, thereby implementing seamless AR.

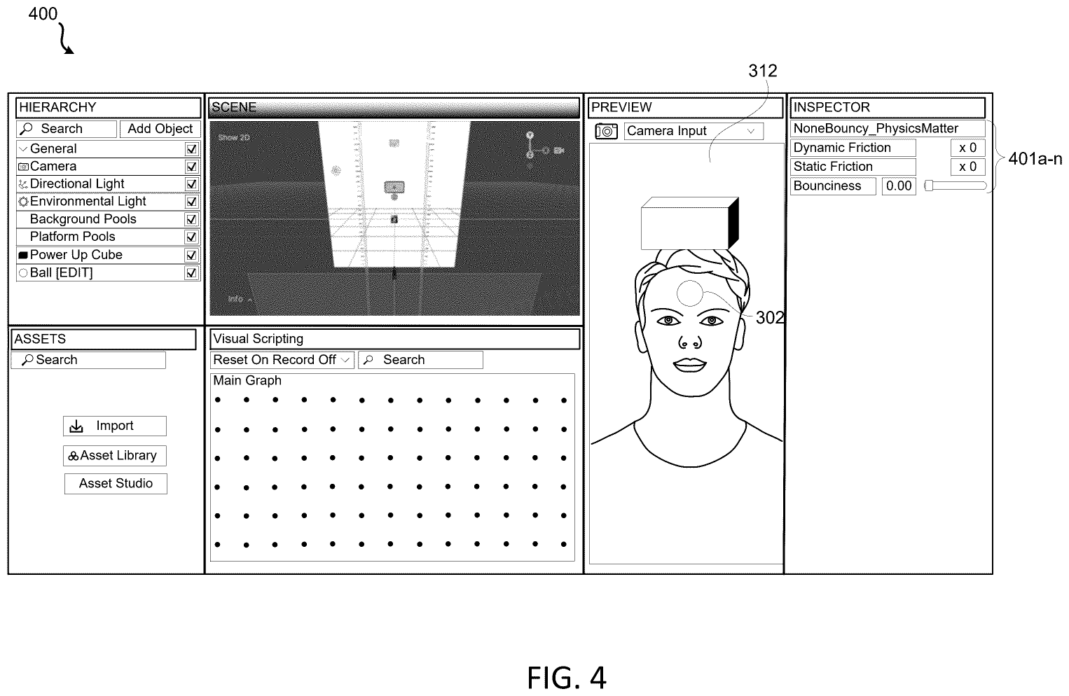

As shown in FIG. 4, the content creation service 118 and/or the application 106 can cause to present the user interface (UI) 400 to the user. The user can use the UI 400 to customize properties of a physics matter that is incorporated into a collider component. For example, the user can customize the physical interaction properties of the sphere collider component assigned to the ball 302 using the user interface elements 401a-n. The user can customize the physical interaction properties to define the interaction properties of the surface of an object (e.g., the ball 302). For example, the user can customize the levels of dynamic friction and/or static friction to control the resistance encountered during motion and at rest. The user can customize a bounciness (e.g., by adjusting a slider from 0 to 1). The bounciness can determine the elasticity of collisions.

The objects and interactions between the objects in the 3D environment can be configured based on user input received via user interfaces (e.g., UIs 200, 300, 400). The content creation service 118 and/or the application 106 can facilitate to create (e.g., generate) content based on the configured objects and interactions. If the created content is an effect, such as an interactive effect, the content can be stored locally or stored as effect data 121 in the database 123. If the created content is a game, the content can be stored locally or stored as game data 129 in the database 123. The stored content can be used by other users. For example, the content creation service 118 can distribute the stored effect data 121 to other client devices. Users associated with the other client devices can utilize the effect data 121 to generate content, such as images or videos. Similarly, the content creation service 118 can distribute the stored game data 129 to other client devices. Users associated with the other client devices can utilize the game data 129 to play the associated game and/or to generate content associated with the game data 129.

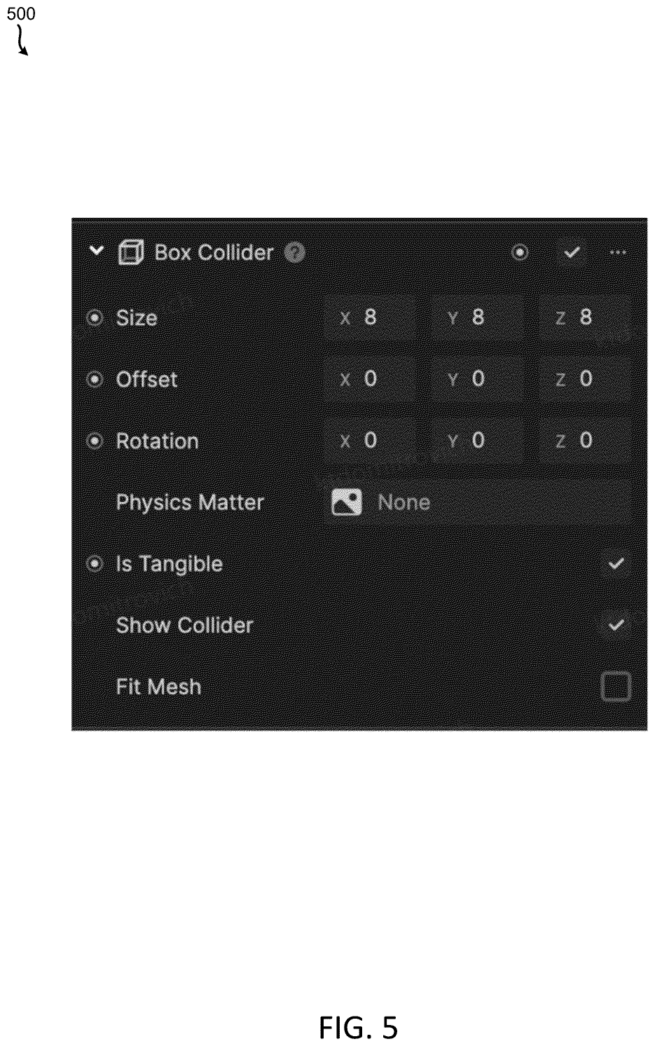

As shown in FIG. 5, the content creation service 118 and/or the application 106 can cause to present a UI 500 to the user. The user can use the UI 500 to customize physical properties of a box collider component. The user can customize the size, offset, rotation, the physics matter, whether the box collider component is tangible, whether the box collider component should be visible, and/or whether the user wants a mesh to be fit to the box collider component. The user can customize the size and/or offset of the box collider component using a 3D vector input (e.g., input/select/specify values for X, Y, Z dimensions, respectively) that defines the dimensions of the box collider and its positional offset relative to the object. The user can customize the rotation of the box collider component using a 3D vector input for adjusting the orientation of the box collider component. The user can customize the physics matter using a material asset that defines the physical properties of the box collider component, such as friction and bounciness. The user can indicate whether the box collider component is tangible and/or whether the box collider component should be visible using Boolean settings that toggle physical solidity and visual representation of the box collider, enhancing development efficiency.

The user can fit a mesh to the box collider. The fit mesh is an innovative feature that automatically adjusts the collider size to match the object's mesh, significantly simplifying the setup process. Fitting a mesh to the box collider component can include automatically adjusting the box collider component to match a mesh size of the object (e.g., the cube 203) to enhance efficiency of effect creation. When the “fit mesh” feature is enabled for a box collider, the content creation service 118 and/or the application 106 can calculate the axis-aligned bounding box (AABB) of the attached mesh. The AABB is a box that completely surrounds the mesh and is aligned with the coordinate axes, meaning its edges are parallel to the axes. The dimensions of the AABB (width, height, and depth) can then be used to set the size of the box collider component. The center of the AABB can be used to set the center of the box collider component. The box collider component can update in real-time as changes are made to the mesh. If the mesh is modified, the box collider component can automatically adjust its size and center to fit the new shape of the mesh.

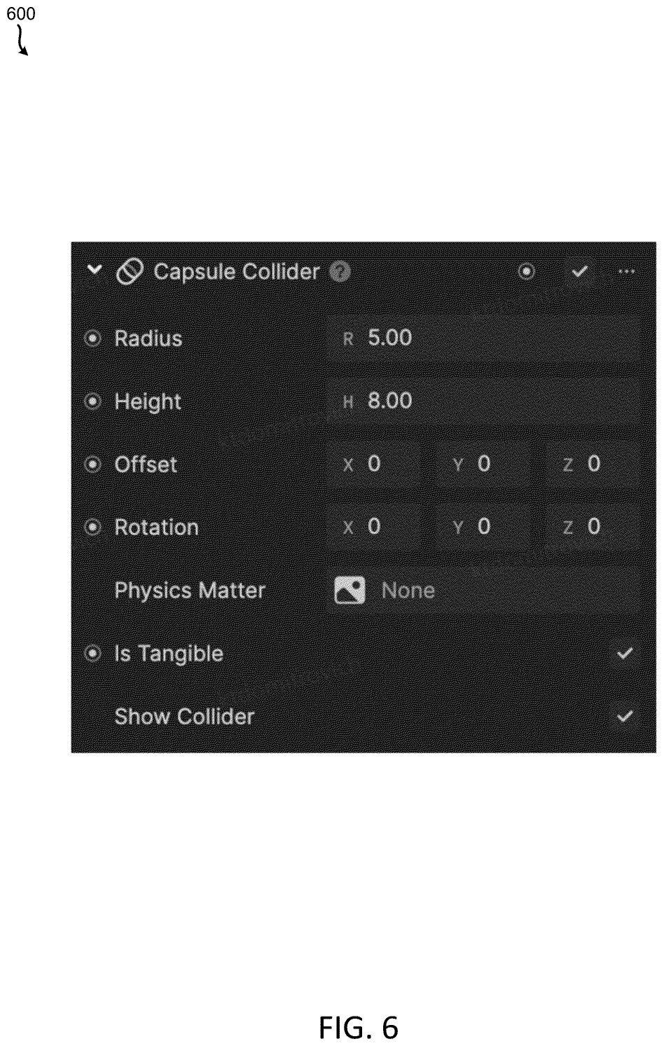

As shown in FIG. 6, the content creation service 118 and/or the application 106 can cause to present a UI 600 to the user. The user can use the UI 600 to customize physical properties of a capsule collider component. The user can customize the radius, height, offset, rotation, the physics matter, whether the capsule collider component is tangible, and/or whether the capsule collider component should be visible. The user can customize the radius and/or height of the capsule collider component by assigning a value (e.g., numeral value) to the radius and/or height. The user can customize the offset of the capsule collider component using a 3D vector input (e.g., input/select/specify values in X, Y, Z dimensions, respectively) that defines the positional offset of the capsule collider component relative to the object. The user can customize the rotation of the capsule collider component using a 3D vector input for adjusting the orientation of the capsule collider component. The user can customize the physics matter using a material asset that defines the physical properties of the capsule collider component, such as friction and bounciness. The user can indicate whether the capsule collider component is tangible and/or whether the capsule collider component should be visible using Boolean settings that toggle physical solidity and visual representation of the capsule collider, enhancing development efficiency.

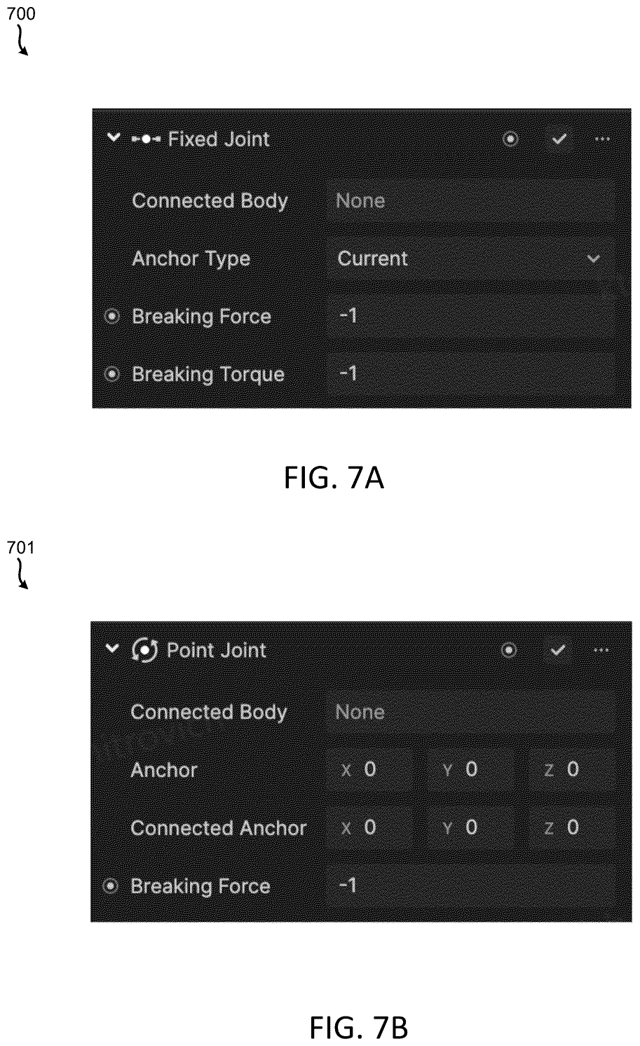

The content creation service 118 and/or the application 106 can cause to present the UIs 700 and 701 shown in FIGS. 7A-B to the user. The user can use UI 700 to customize the physical properties of a fixed joint. A fixed joint can enable a fixed attachment between two or more objects. The user can specify one or more connected bodies (e.g., the other object(s) in the joint connection). The user can specify one or more anchor types for the fixed joint. The user can define a breaking force and/or torque for the fixed joint. The breaking force can be the minimum force at which the joint breaks when a constantly increasing force is applied to it. The breaking torque can be the tightening torque necessary for the joint to break.

As shown by the UI 701, a user can customize the physical properties of a point joint. A point joint can enable a point-based joint between two objects. The user can specify one or more connected bodies (e.g., the object(s) in the point connection). The user can specify one or more anchors points and/or connected anchor points for the point joint. The anchor points can define the local connection points on each object, with 3D vector inputs (in X, Y, Z dimensions). The user can define a breaking force and/or torque for the point-based joint. The breaking force can be the limit at which the point-based joint will fail, adding realism and dynamic breakage to simulations.

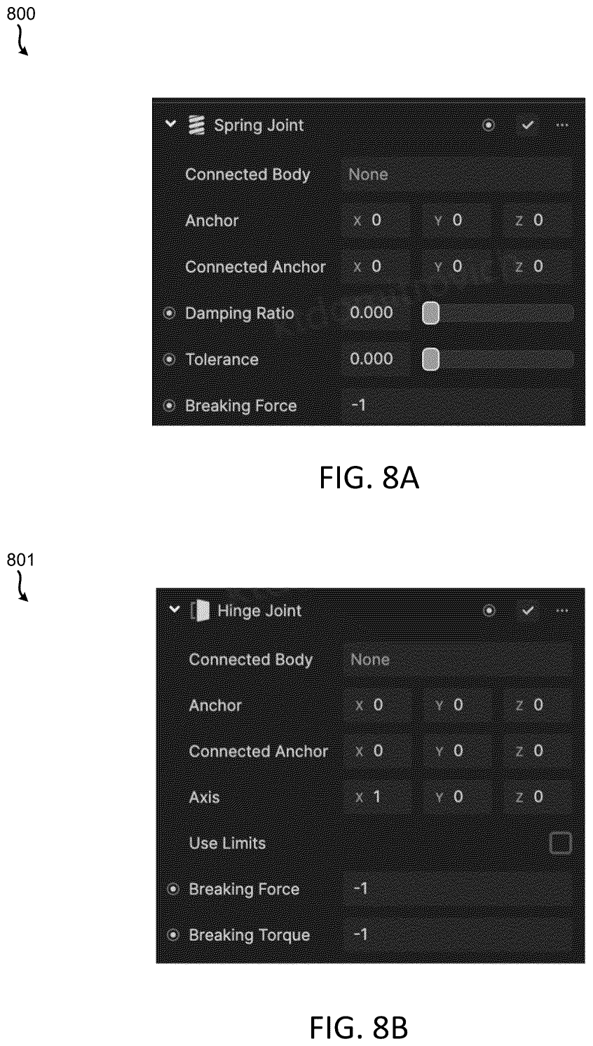

The content creation service 118 can present the UIs 800 and 801 shown in FIGS. 8A-B to the user. The user can use the UI 800 to customize the physical properties of a spring joint. A spring joint can enable an attachment between two or more objects while allowing spring-like movement of the two or more objects. The user can specify one or more connected bodies (e.g., the object(s) connected by the spring joint). The user can specify one or more anchors springs and/or connected anchor springs for the spring joint. The anchor springs can define the local connection points on each object, with 3D vector inputs. The user can define a breaking force and/or torque for the spring-based joint. The breaking force can be the limit at which the spring-based joint will fail, adding realism and dynamic breakage to simulations. The user can define a damping ratio and/or a tolerance for the spring-based joint, enhancing the versatility and realism of object interactions. The damping ratio can be a dimensionless measure describing how oscillations of the spring-based joint decay after a disturbance. The tolerance can be a measure of the allowance of a permissible range in force per inch (or millimeter) applied to the spring-based joint.

As shown by the UI 801, a user can customize the physical properties of a hinge joint. A hinge joint can enable an attachment between two or more objects while allowing hinge-like movement of the two or more objects. The user can specify one or more connected bodies (e.g., the object(s) connected by the hinge joint). The user can specify one or more anchors hinges and/or connected anchor hinges for the hinge joint. The anchor hinges can define the local connection points on each object, with 3D vector inputs. The user can define a breaking force and/or torque for the hinge-based joint. The breaking force can be the limit at which the hinge-based joint will fail, adding realism and dynamic breakage to simulations. The user can define an axis and/or use limit for the hinge-based joint, enhancing the versatility and realism of object interactions. The user can define a breaking force and/or torque for the hinge joint. The breaking force can be the limit at which the joint will fail, adding realism and dynamic breakage to simulations.

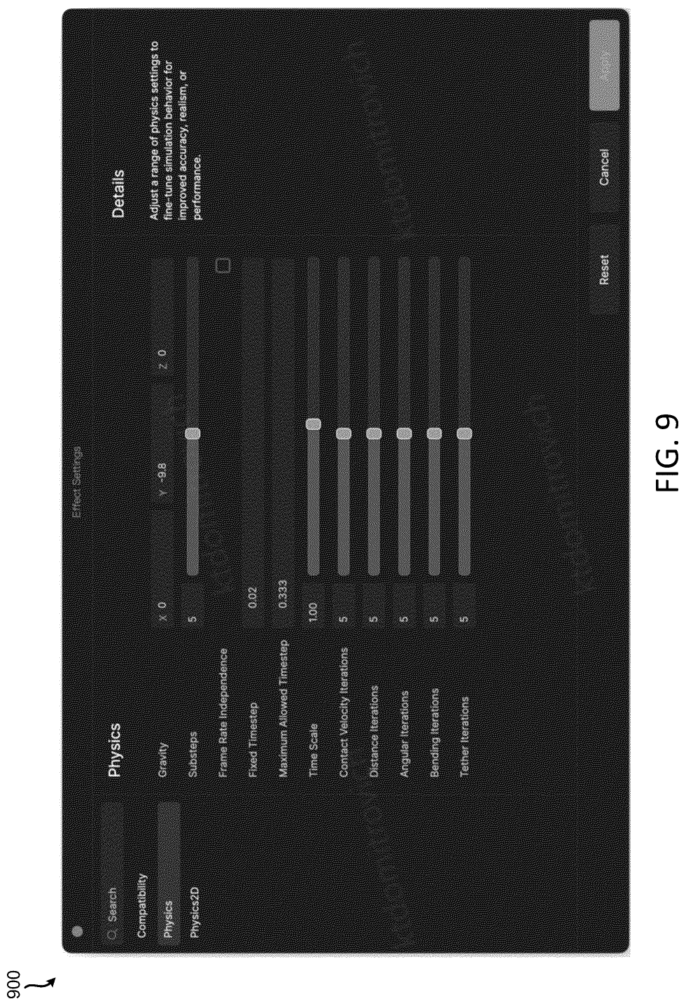

As shown in FIG. 9, the content creation service 118 and/or the application 106 can cause to present a UI 900 to the user. The user can use the UI 900 for adjusting global physics settings. A user can fine-tune physics simulations by adjusting global physics settings to improve accuracy and realism of the interactive effects. For example, the user can adjust a magnitude and/or direction of the gravity force. The user can customize the magnitude and/or direction of the gravitational force using a 3D vector input.

The UI 900 enables the user to adjust a number of sub-steps for the physics simulation. The total frame time for the physics simulation can be divided into the number of sub-steps. A larger number of sub-steps can result in a more stable simulation at a greater CPU cost. The user can use the UI 900 for adjusting a fixed timestep and/or a maximum allowed timestep. The “timestep” is a rate at which the physics simulation is to be run (e.g., the time interval for which the physics simulation will progress during the next “step.”). The user can use the UI 900 for adjusting the time scale of the physics simulation. The time scale can indicate a speed of the physics simulation.

The user can configure contact velocity iterations and/or position iterations to implement a precise control over interaction realism and performance optimization. The user can customize the contact velocity iterations and/or position iterations by adjusting sliders from 0 to 10. The user can use the UI 900 for adjusting a number of contact velocity iterations. The number of contact velocity iterations can be the quantity of iterations for calculating the velocity of objects upon contact. Higher values can improve accuracy but may impact performance. The user can use the UI 900 for adjusting a number of distance iterations. The number of distance iterations can be the number of cycles for correcting object distance. The user can use the UI 900 for adjusting a number of angular iterations. The number of angular iterations can be the number of cycles for correcting object angles. The user can use the UI 900 for adjusting a number of bending iterations. The number of bending iterations can be the number of cycles for correcting object bending. The user can use the UI 900 for adjusting a number of tether iterations. The number of tether iterations can be the number of cycles for correcting object tethering.

It should be appreciated that, while the content creation service 118 can facilitate the creation/design of content in the manner described above, the client devices 104 can additionally, or alternatively, facilitate the local creation/design of content using the set of physics tools 116. For example, the client devices 104, via the application 106, can establish the set of physics tools 116. The set of physics tools 116 can be stored locally on the client devices 104. Alternatively, the client devices 104 can receive (e.g., retrieve) data indicative of the set of physics tools 116 from a remote storage, such as from the cloud network 102. The client devices 104 can present user interfaces (e.g., UI 200, UI 300, UI 400, UI 500, UI 600, UI 700, UI 800, and/or UI 900), such as via the interface 108 of the application 106. The user interfaces can facilitate application of the physics simulations in the 3D environment. The client devices 104 can configure objects and interactions in the 3D environment by utilizing the set of physics tools based on user input received via the user interfaces. The client devices 104 can create interactive effects based on the configured objects and interactions.

The content creation service 118 and/or the application 106 described above can enhanced realism and engagement in the content creation process by enabling complex and customizable physics simulations. The content, such as the games and AR effects, created using the content creation service 118 and/or the application 106 can be realistic and immersive. Further, the content creation service 118 and/or the application 106 described above increases creative freedom, as creators can now experiment with a wider range of physical interactions and behaviors, pushing the boundaries of what can be achieved in digital game and effect creation. The content creation service 118 and/or the application 106 enables a streamlined development process. The efficiency of the development process is greatly improved, lowering the barrier to entry for creating physics-based content and enabling faster iteration and innovation. The content creation service 118 and/or the application 106 creates expanded possibilities for AR and Interactive experiences. The optimization for AR and interactive use cases opens up new possibilities for engaging and interactive content that was previously unattainable due to technical limitations.

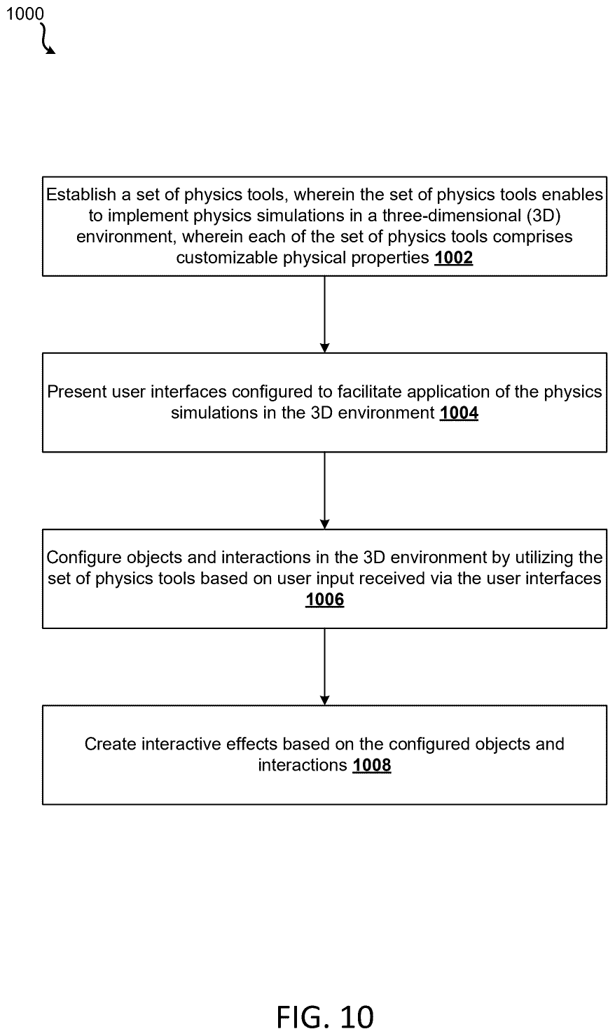

FIG. 10 illustrates an example process 1000 for creating physics-based content in accordance with the present disclosure. The process 1000 can be performed, for example, by the content creation service 118 and/or the application 106. Although depicted as a sequence of operations in FIG. 10, those of ordinary skill in the art will appreciate that various embodiments may add, remove, reorder, or modify the depicted operations.

At 1002, a set of physics tools (e.g., physics tools 116) can be established. The set of physics tools can enable to implement physics simulations in a 3D environment. Each of the set of physics tools comprises customizable physical properties. The set of physics tools can include one or more rigid body components. The rigid body component(s) can each include customizable physical properties, such as properties of mass, damping, angular damping, external force, external torque, and/or a freeze option for motion along specified axes. The set of physics tools can further include one or more collider components. The collider component(s) can include a box collider configured to detect and simulate collisions involving box-shaped objects. The collider component(s) can include a sphere collider configured to detect and simulate collisions involving sphere-shaped objects. The collider component(s) can include a capsule collider configured to detect and simulate collisions involving capsule-shaped objects. The set of physics tools can also include one or more joint components. The joint component(s) can include fixed joints, point joints, spring joints, and/or hinge joints. The joint components can simulate physical connections between objects.

At 1004, user interfaces (e.g., UI 200, UI 300, UI 400, UI 500, UI 600, UI 700, UI 800, and/or UI 900) can be presented. The user interfaces can be configured to facilitate application of the physics simulations in the 3D environment. A user can input, via one or more of the user interfaces, data indicating a desired configuration of various objects and interactions between the objects in the 3D environment. At 1006, objects and interactions can be configured in the 3D environment. The objects and interactions can be configured using the set of physics tools based on user input received via the user interfaces. At 1008, interactive effects can be created based on the configured objects and interactions. The interactive effects can include AR effects and/or games.

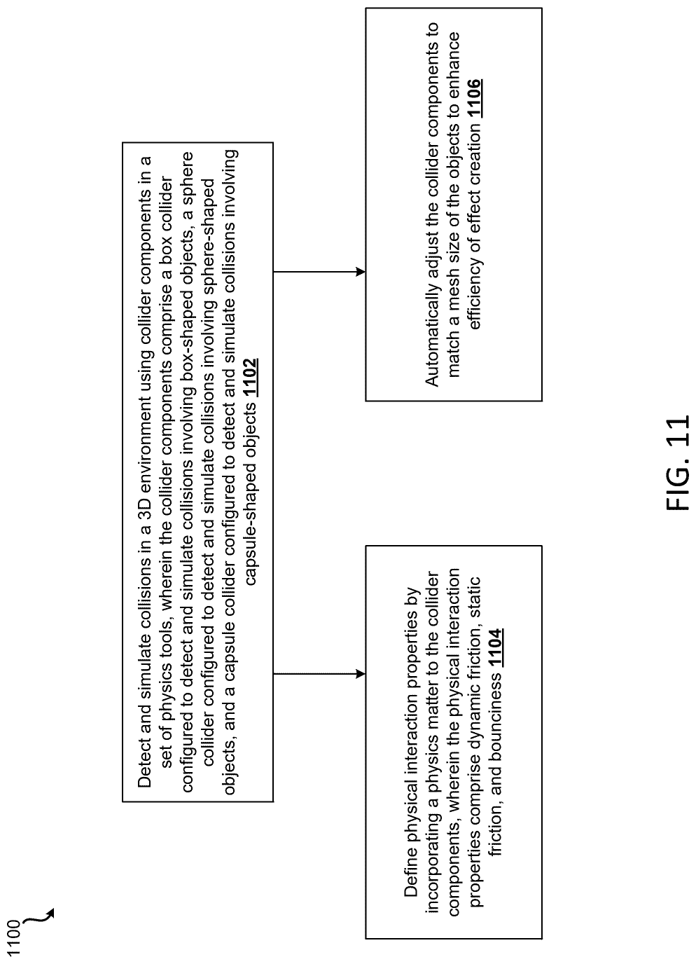

FIG. 11 illustrates an example process 1100 for creating physics-based content in accordance with the present disclosure. The process 1100 can be performed, for example, by the content creation service 118 and/or the application 106. Although depicted as a sequence of operations in FIG. 11, those of ordinary skill in the art will appreciate that various embodiments may add, remove, reorder, or modify the depicted operations.

At 1102, collisions in a 3D environment can be detected and/or simulated. The collisions can be detected and/or simulated using collider components comprised in a set of physics tools (e.g., physics tools 116). The collider components can include a box collider configured to detect and simulate collisions involving box-shaped objects. The collider components can include a sphere collider configured to detect and simulate collisions involving sphere-shaped objects. The collider components can include a capsule collider configured to detect and simulate collisions involving capsule-shaped objects.

At 1104, physical interaction properties can be defined. The physical interaction properties can be defined by incorporating a physics matter to the collider components. The physical interaction properties can include one or more of dynamic friction, static friction, and bounciness. For example, a user can customize the levels of dynamic friction and/or static friction to controls the resistance encountered during motion and at rest. The user can customize a bounciness (e.g., by adjusting a slider from 0 to 1). The bounciness can determine the elasticity of collisions.

A mesh can be fit to box collider components and sphere collider components. At 1106, the collider components can be automatically adjusted to match a mesh size of the objects to enhance efficiency of effect creation. When the “fit mesh” feature is enabled for a sphere collider, a bounding sphere of the attached mesh can be calculated. The bounding sphere is the smallest possible sphere that completely surrounds the mesh. The radius of the bounding sphere can be used to set the radius of the sphere collider. The center of the bounding sphere can be used to set the center of the sphere collider. The sphere collider can update in real-time as changes are made to the mesh. When the “fit mesh” feature is enabled for a box collider, the AABB of the attached mesh can be calculated. The AABB is a box that completely surrounds the mesh and is aligned with the coordinate axes, meaning its edges are parallel to the axes. The dimensions of the AABB (width, height, and depth) can then be used to set the size of the box collider component. The center of the AABB can be used to set the center of the box collider component. The box collider component can update in real-time as changes are made to the mesh.

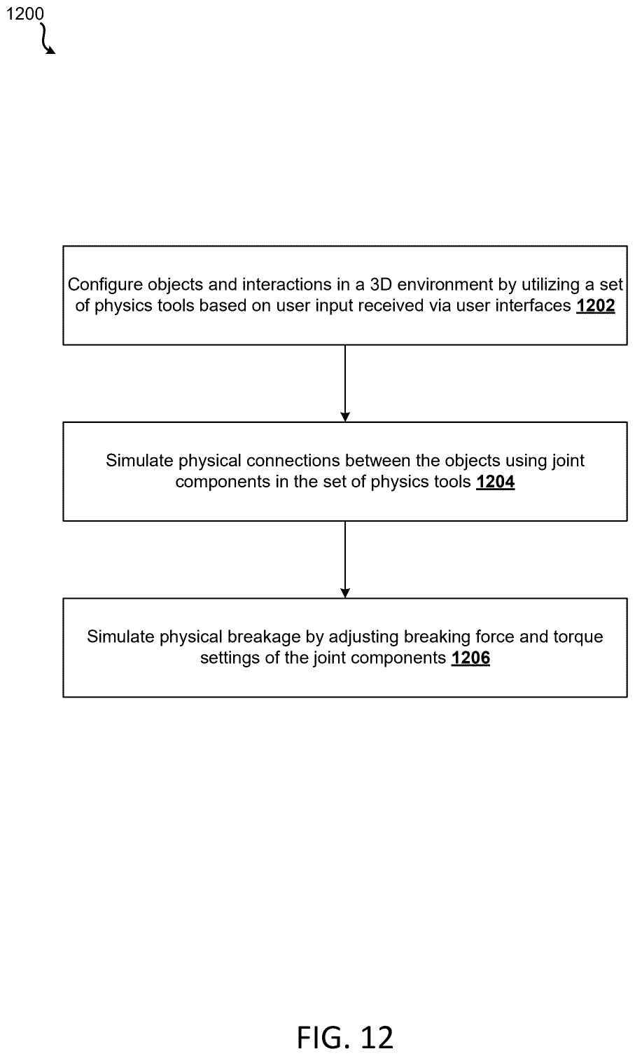

FIG. 12 illustrates an example process 1200 for creating physics-based content in accordance with the present disclosure. The process 1200 can be performed, for example, by the content creation service 118 and/or the application 106. Although depicted as a sequence of operations in FIG. 12, those of ordinary skill in the art will appreciate that various embodiments may add, remove, reorder, or modify the depicted operations.

User interfaces (e.g., UI 200, UI 300, UI 400, UI 500, UI 600, UI 700, UI 800, and/or UI 900) can be presented. The user interfaces can be configured to facilitate application of the physics simulations in the 3D environment. A user can input, via one or more of the user interfaces, data indicating a desired configuration of various objects and interactions between the objects in the 3D environment. At 1202, objects and interactions can be configured in the 3D environment. The objects and interactions can be configured using a set of physics tools based on user input received via the user interfaces.

The set of physics tools can include one or more joint components. The joint component(s) can include fixed joints, point joints, spring joints, and/or hinge joints. The joint components can simulate physical connections between objects. At 1204, physical connections between the objects can be simulated. The physical connections can be simulated using the joint components in the set of physics tools. At 1206, physical breakage of the joint components can be simulated. The physical breakage of the joint components can be simulated by adjusting a breaking force and/or torque setting of the joint components. The breaking force can be the limit at which the joint will fail, adding realism and dynamic breakage to simulations.

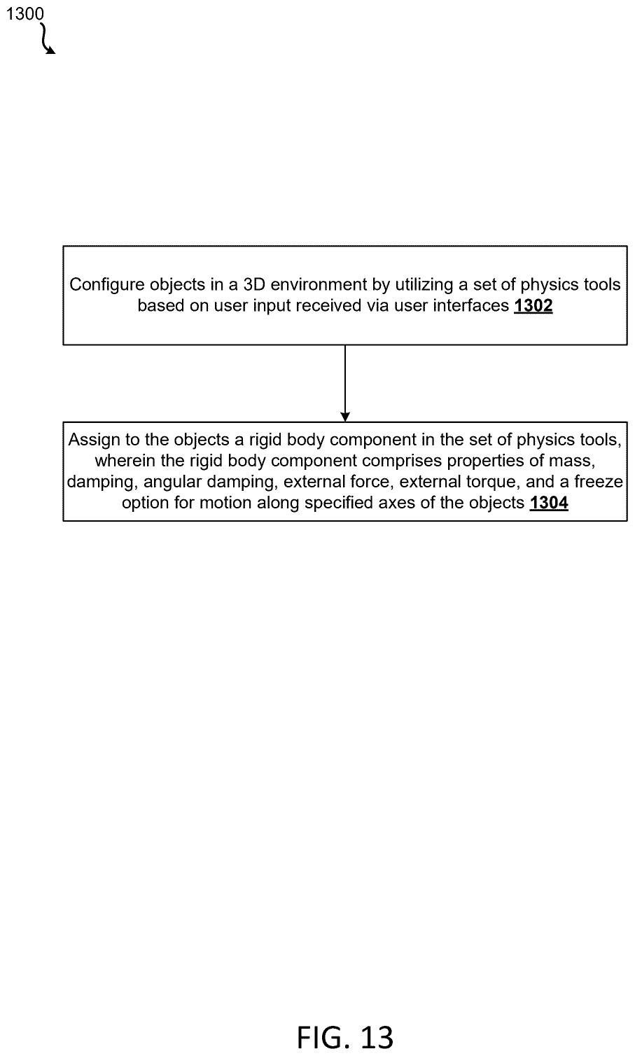

FIG. 13 illustrates an example process 1300 for creating physics-based content in accordance with the present disclosure. The process 1300 can be performed, for example, by the content creation service 118 and/or the application 106. Although depicted as a sequence of operations in FIG. 13, those of ordinary skill in the art will appreciate that various embodiments may add, remove, reorder, or modify the depicted operations.

User interfaces (e.g., UI 200, UI 300, UI 400, UI 500, UI 600, UI 700, UI 800, and/or UI 900) can be presented. The user interfaces can be configured to facilitate application of the physics simulations in the 3D environment. A user can input, via one or more of the user interfaces, data indicating a desired configuration of various objects and interactions between the objects in the 3D environment. At 1302, objects and interactions can be configured in the 3D environment. The objects and interactions can be configured using the set of physics tools based on user input received via the user interfaces. The set of physics tools can include rigid body components. At 1304, a rigid body component in the set of physics tools can be assigned to the objects. The rigid body component can comprise or be associated with properties of mass, damping, angular damping, external force, external torque, and a freeze option for motion along specified axes of the objects. A user can customize the properties to enable realistic physics simulations for the content.

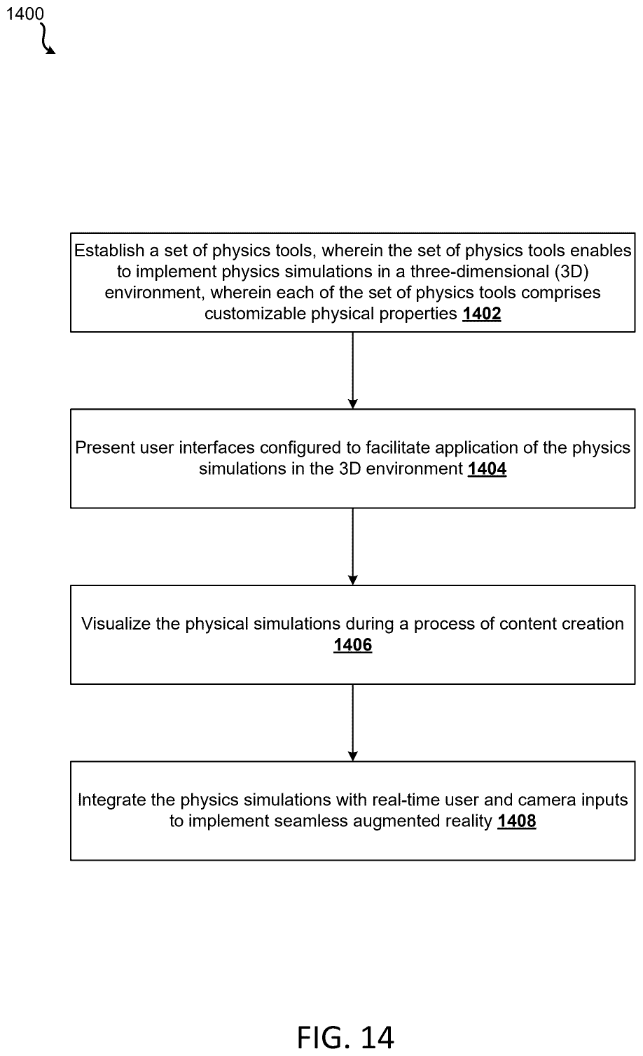

FIG. 14 illustrates an example process 1400 for creating physics-based content in accordance with the present disclosure. The process 1400 can be performed, for example, by the content creation service 118 and/or the application 106. Although depicted as a sequence of operations in FIG. 14, those of ordinary skill in the art will appreciate that various embodiments may add, remove, reorder, or modify the depicted operations.

At 1402, a set of physics tools (e.g., physics tools 116) can be established. The set of physics tools can enable the implementation of physics simulations in a 3D environment. Each of the set of physics tools comprises customizable physical properties. The set of physics tools can include one or more rigid body components. The rigid body component(s) can each include customizable physical properties, such as properties of mass, damping, angular damping, external force, external torque, and/or a freeze option for motion along specified axes. The set of physics tools can include one or more collider components. The collider component(s) can include a box collider configured to detect and simulate collisions involving box-shaped objects. The collider component(s) can include a sphere collider configured to detect and simulate collisions involving sphere-shaped objects. The collider component(s) can include a capsule collider configured to detect and simulate collisions involving capsule-shaped objects. The set of physics tools can include one or more joint components. The joint component(s) can include fixed joints, point joints, spring joints, and/or hinge joints. The joint components can simulate physical connections between objects.

At 1404, user interfaces (e.g., UI 200, UI 300, UI 400, UI 500, UI 600, UI 700, UI 800, and/or UI 900) can be presented. The user interfaces can be configured to facilitate application of the physics simulations in the 3D environment. A user can input, via one or more of the user interfaces, data indicating a desired configuration of various objects and interactions between the objects in the 3D environment.

At 1406, the physical simulations can be visualized during a process of content creation. A preview window (e.g., preview window 212) of a 3D environment including the physical simulations can be displayed. The preview window can show the user a current design state of the content (e.g., how the content would look if no more changes or modifications were made to the design of the content). The 3D environment shown in the preview window can be integrating with real-time user and camera inputs. At 1408, the physics simulations can be integrated with real-time user and camera inputs to implement seamless augmented reality. For example, a feed of a camera (e.g., a feed of a camera 110a-n) can be combined with the 3D environment and displayed in the preview window.

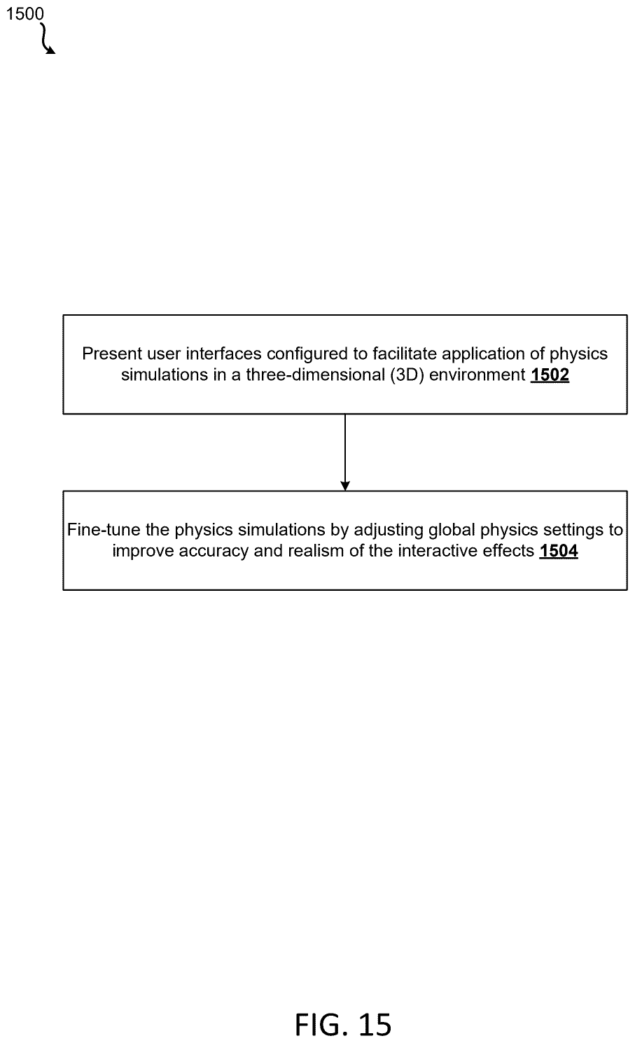

FIG. 15 illustrates an example process 1500 for creating physics-based content in accordance with the present disclosure. The process 1500 can be performed, for example, by the content creation service 118 and/or the application 106. Although depicted as a sequence of operations in FIG. 15, those of ordinary skill in the art will appreciate that various embodiments may add, remove, reorder, or modify the depicted operations.

At 1502, user interfaces (e.g., UI 200, UI 300, UI 400, UI 500, UI 600, UI 700, UI 800, and/or UI 900) can be presented. The user interfaces can be configured to facilitate application of the physics simulations in the 3D environment. A user can input, via one or more of the user interfaces, data indicating a desired configuration of various objects and interactions between the objects in the 3D environment. At 1504, the physics simulations can be fine-tuned. The physics simulations can be fine-tuned by adjusting global physics settings to improve accuracy and realism of the interactive effects.

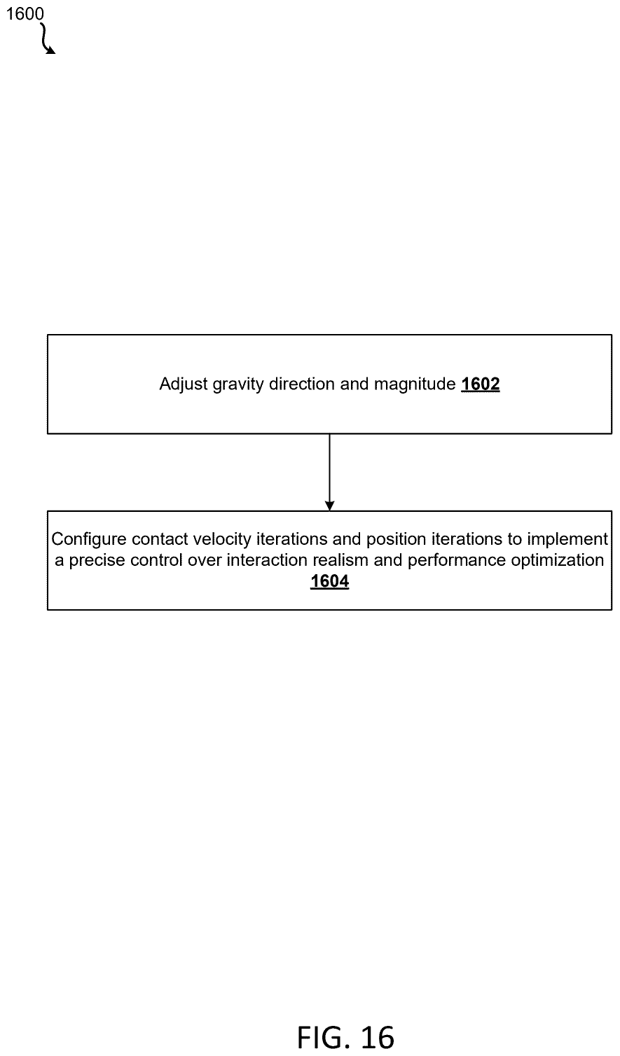

FIG. 16 illustrates an example process 1600 for creating physics-based content in accordance with the present disclosure. The process 1600 can be performed, for example, by the content creation service 118 and/or the application 106. Although depicted as a sequence of operations in FIG. 16, those of ordinary skill in the art will appreciate that various embodiments may add, remove, reorder, or modify the depicted operations.

A user can fine-tune physics simulations by adjusting global physics settings to improve accuracy and realism of the interactive effects. Adjusting global physics settings can include adjusting a gravity direction and/or magnitude. At 1602, a gravity direction and/or a gravity magnitude can be adjusted. The user can customize the magnitude and/or direction of the gravitational force using a 3D vector input. Adjusting global physics settings can include configuring contact velocity iterations and/or position iterations. At 1604, contact velocity iterations and/or position iterations can be configured to implement a precise control over interaction realism and performance optimization. The user can customize the contact velocity iterations and/or position iterations by adjusting sliders from 0 to 10,

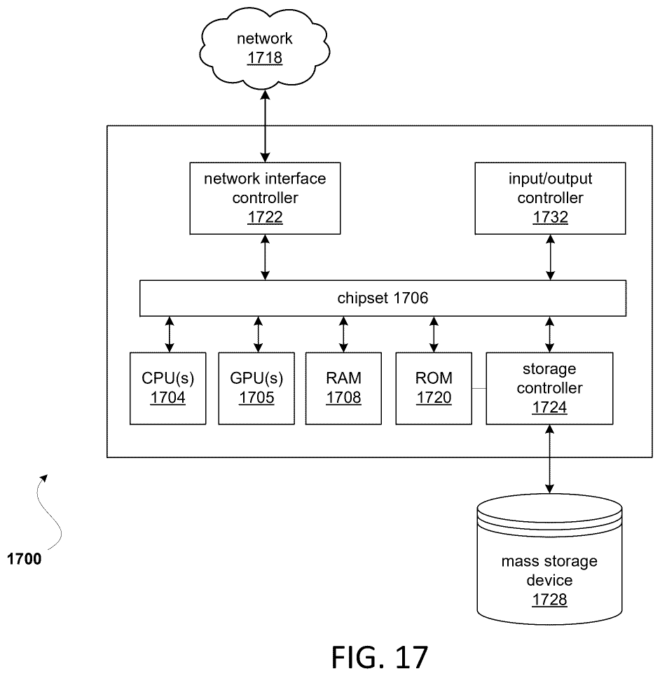

FIG. 17 illustrates a computing device that may be used in various aspects, such as the model(s), components, and/or devices depicted in FIG. 1. With regard to FIG. 1, any or all of the components may each be implemented by one or more instance of a computing device 1700 of FIG. 17. The computer architecture shown in FIG. 17 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1700 may include a baseboard, or “motherboard,” which is a printed circuit board to which a multitude of components or devices may be connected by way of a system bus or other electrical communication paths. One or more central processing units (CPUs) 1704 may operate in conjunction with a chipset 1706. The CPU(s) 1704 may be standard programmable processors that perform arithmetic and logical operations necessary for the operation of the computing device 1700.

The CPU(s) 1704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1704 may be augmented with or replaced by other processing units, such as GPU(s) 1705. The GPU(s) 1705 may comprise processing units specialized for but not necessarily limited to highly parallel computations, such as graphics and other visualization-related processing.

A chipset 1706 may provide an interface between the CPU(s) 1704 and the remainder of the components and devices on the baseboard. The chipset 1706 may provide an interface to a random-access memory (RAM) 1708 used as the main memory in the computing device 1700. The chipset 1706 may further provide an interface to a computer-readable storage medium, such as a read-only memory (ROM) 1720 or non-volatile RAM (NVRAM) (not shown), for storing basic routines that may help to start up the computing device 1700 and to transfer information between the various components and devices. ROM 1720 or NVRAM may also store other software components necessary for the operation of the computing device 1700 in accordance with the aspects described herein.

The computing device 1700 may operate in a networked environment using logical connections to remote computing nodes and computer systems through local area network (LAN). The chipset 1706 may include functionality for providing network connectivity through a network interface controller (NIC) 1722, such as a gigabit Ethernet adapter. A NIC 1722 may be capable of connecting the computing device 1700 to other computing nodes over a network 1718. It should be appreciated that multiple NICs 1722 may be present in the computing device 1700, connecting the computing device to other types of networks and remote computer systems.

The computing device 1700 may be connected to a mass storage device 1728 that provides non-volatile storage for the computer. The mass storage device 1728 may store system programs, application programs, other program modules, and data, which have been described in greater detail herein. The mass storage device 1728 may be connected to the computing device 1700 through a storage controller 1724 connected to the chipset 1706. The mass storage device 1728 may consist of one or more physical storage units. The mass storage device 1728 may comprise a management component 1710. A storage controller 1724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1700 may store data on the mass storage device 1728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1728 is characterized as primary or secondary storage and the like.

For example, the computing device 1700 may store information to the mass storage device 1728 by issuing instructions through a storage controller 1724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1700 may further read information from the mass storage device 1728 by detecting the physical states or characteristics of one or more particular locations within the physical storage units.

In addition to the mass storage device 1728 described above, the computing device 1700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1728 depicted in FIG. 17, may store an operating system utilized to control the operation of the computing device 1700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1728 may store other system or application programs and data utilized by the computing device 1700.

The mass storage device 1728 or other computer-readable storage media may also be encoded with computer-executable instructions, which, when loaded into the computing device 1700, transforms the computing device from a general-purpose computing system into a special-purpose computer capable of implementing the aspects described herein. These computer-executable instructions transform the computing device 1700 by specifying how the CPU(s) 1704 transition between states, as described above. The computing device 1700 may have access to computer-readable storage media storing computer-executable instructions, which, when executed by the computing device 1700, may perform the methods described herein, such as the methods shown in FIGS. 11-17.

A computing device, such as the computing device 1700 depicted in FIG. 17, may also include an input/output controller 1732 for receiving and processing input from a number of input devices, such as a keyboard, a mouse, a touchpad, a touch screen, an electronic stylus, or other type of input device. Similarly, an input/output controller 1732 may provide output to a display, such as a computer monitor, a flat-panel display, a digital projector, a printer, a plotter, or other type of output device. It will be appreciated that the computing device 1700 may not include all of the components shown in FIG. 17, may include other components that are not explicitly shown in FIG. 17, or may utilize an architecture completely different than that shown in FIG. 17.

As described herein, a computing device may be a physical computing device, such as the computing device 1700 of FIG. 17. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of creating physics-based content, comprising:
establishing a set of physics tools, wherein the set of physics tools enables to implement physics simulations in a three-dimensional (3D) environment, wherein each of the set of physics tools comprises customizable physical properties;
presenting user interfaces configured to facilitate application of the physics simulations in the 3D environment;
configuring objects and interactions in the 3D environment by utilizing the set of physics tools based on user input received via the user interfaces; and
creating interactive effects based on the configured objects and interactions.

2. The method of claim 1, further comprising:
detecting and simulating collisions in the 3D environment using collider components in the set of physics tools.

3. The method of claim 2, further comprising:
defining physical interaction properties by incorporating a physics matter to the collider components, wherein the physical interaction properties comprise dynamic friction, static friction, and bounciness.

4. The method of claim 2, further comprising:
automatically adjusting the collider components to match a mesh size of the objects.

5. The method of claim 2, wherein the collider components comprise a box collider configured to detect and simulate collisions involving box-shaped objects, a sphere collider configured to detect and simulate collisions involving sphere-shaped objects, and a capsule collider configured to detect and simulate collisions involving capsule-shaped objects.

6. The method of claim 1, further comprising:
simulating physical connections between the objects using joint components in the set of physics tools.

7. The method of claim 6, further comprising:
simulating physical breakage by adjusting breaking force and torque settings of the joint components.

8. The method of claim 1, further comprising:
assigning to the objects a rigid body component in the set of physics tools, wherein the rigid body component comprises properties of mass, damping, angular damping, external force, external torque, and a freeze option for motion along specified axes of the objects.

9. The method of claim 1, further comprising:
visualizing the physical simulations during a process of content creation.

10. The method of claim 1, further comprising:
integrating the physics simulations with real-time user and camera inputs.

11. The method of claim 1, further comprising:
fine-tuning the physics simulations by adjusting global physics settings.

12. The method of claim 11, further comprising:
adjusting gravity direction and magnitude; and
configuring contact velocity iterations and position iterations.

13. A system of creating physics-based content, comprising:
at least one processor; and
at least one memory communicatively coupled to the at least one processor and comprising computer-readable instructions that upon execution by the at least one processor cause the at least one processor to perform operations comprising:
establishing a set of physics tools, wherein the set of physics tools enables to implement physics simulations in a three-dimensional (3D) environment, wherein each of the set of physics tools comprises customizable physical properties;
presenting user interfaces configured to facilitate application of the physics simulations in the 3D environment;
configuring objects and interactions in the 3D environment by utilizing the set of physics tools based on user input received via the user interfaces; and
creating interactive effects based on the configured objects and interactions.

14. The system of claim 13, the operations further comprising:
detecting and simulating collisions in the 3D environment using collider components in the set of physics tools.

15. The system of claim 13, the operations further comprising:
simulating physical connections between the objects using joint components in the set of physics tools.

16. The system of claim 13, the operations further comprising:
assigning to the objects a rigid body component in the set of physics tools, wherein the rigid body component comprises properties of mass, damping, angular damping, external force, external torque, and a freeze option for motion along specified axes of the objects.

17. A non-transitory computer-readable storage medium, storing computer-readable instructions that upon execution by a processor cause the processor to implement operations comprising:
establishing a set of physics tools, wherein the set of physics tools enables to implement physics simulations in a three-dimensional (3D) environment, wherein each of the set of physics tools comprises customizable physical properties;
presenting user interfaces configured to facilitate application of the physics simulations in the 3D environment;
configuring objects and interactions in the 3D environment by utilizing the set of physics tools based on user input received via the user interfaces; and
creating interactive effects based on the configured objects and interactions.

18. The non-transitory computer-readable storage medium of claim 17, the operations further comprising:
detecting and simulating collisions in the 3D environment using collider components in the set of physics tools.

19. The non-transitory computer-readable storage medium of claim 17, the operations further comprising:
simulating physical connections between the objects using joint components in the set of physics tools.

20. The non-transitory computer-readable storage medium of claim 17, the operations further comprising:
assigning to the objects a rigid body component in the set of physics tools, wherein the rigid body component comprises properties of mass, damping, angular damping, external force, external torque, and a freeze option for motion along specified axes of the objects.
